(19) United States
(12) Patent Application Publication
(10) Pub. No.: US 2013/0211809 A1
(43) Pub. Date: Aug. 15, 2013

(54) EVALUATION SUPPORT METHOD AND EVALUATION SUPPORT APPARATUS

(71) Applicant: Fujitsu Limited, (US)

(72) Inventor: Tetsutaro MARUYAMA, Kawasaki (JP)

(21) Appl. No.: 13/705,279

(22) Filed: Dec. 5, 2012

(30) Foreign Application Priority Data
Feb. 13, 2012 (JP) 2012-028933

(51) Int. Cl. G06F 17/50

(52) U.S. Cl. CPC G06F 17/5031
USPC 703/21

(57) ABSTRACT

A computer-readable recording medium stores a program that causes a computer to execute an evaluation support process that includes calculating a response time for a read request based on multiplicity and a maximal number of requests wherein the multiplicity is the number of overlaps of read or write processes for a storage apparatus per unit time, and the maximal number of requests is the number of read requests that the storage apparatus processes per unit time; and creating, based on the response time, the maximal number of requests, and a minimal response time for the read request, a response model that represents a response time that has the number of read requests as exponent and exponentially increases as the number of read requests increases.

### CROSS REFERENCE TO RELATED APPLICATIONS

This application is based upon and claims the benefit of priority of the prior Japanese Patent Application No. 2012-028933, filed on Feb. 13, 2012, the entire contents of which are incorporated herein by reference.

### FIELD

The embodiments discussed herein are related to an evaluation support program, an evaluation support method and an evaluation support apparatus.

### BACKGROUND

As virtualization and cloud computing develop, the consolidation of servers and the incorporation of a server in the cloud computing architecture are promoted. Storage is also expected to be consolidated. In the case of the consolidation of storage, multitenancy and quality of service (QoS) are required. With multitenancy, the data of one user is protected from other users, preventing the access by other users. QoS guarantees a certain level of communication quality.

When hardware is provided for each user, the performance of storage depends on the hardware and is not much affected by other users. However, once storage is consolidated, multiple users utilize the same hardware. Therefore, the prediction or monitoring of the performance for each user or control via software becomes important.

An example of a conventional technology is mentioned here. A storage system includes a host computer that issues input and output commands and a storage device that executes an input/output commands processing. The performance of the storage system is monitored. An initial reference value is calculated from statistical data that is obtained from the measurement of the performance of a logical disk to which input/output commands are given, and a predicted reference value is acquired by adding to the statistical data information concerning the performance under a situation where input/output commands are executed in a usual working condition (see, for example, Japanese Laid-open Patent Publication No. 2010-113383).

However, according to the conventional technology, it is difficult to evaluate the performance of storage when multiple users use the same hardware. For example, in the case of simulation where the operation of firmware within hardware is replaced with software, the processing load and time required for the simulation increase.

### SUMMARY

According to an aspect of an embodiment, a computer-readable recording medium stores a program that causes a computer to execute an evaluation support process that includes calculating a response time for a read request based on multiplicity and a maximal number of requests wherein the multiplicity is the number of overlaps of read or write processes for a storage apparatus per unit time, and the maximal number of requests is the number of read requests that the storage apparatus processes per unit time; and creating, based on the response time, the maximal number of requests, and a minimal response time for the read request, a response model that represents a response time that has the number of read requests as exponent and exponentially increases as the number of read requests increases.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting one example of an evaluation support method;

FIG. 2 is a diagram depicting a hardware configuration of an evaluation support apparatus 101;

FIG. 3 is a diagram depicting an example of apparatus information;

FIG. 4 is a diagram depicting an example of load information;

FIG. 5 is a diagram depicting an example of multiplicity;

FIG. 6 is a diagram depicting a functional configuration of the evaluation support apparatus 101;

FIG. 7 is a diagram depicting the relation between an estimate and a measurement of maximal IOPS (X₃₀);

FIG. 8 is a diagram depicting the relation between an estimate and a measurement of minimal response time Tₘᵢₙ;

FIG. 9 is a diagram depicting the relation between an estimate and a measurement of a response time W;

FIG. 10 is a diagram depicting the relation between an estimate and a measurement of the response time W;

FIG. 11 is a diagram depicting an operation of a storage apparatus 102 in response to a write request;

FIG. 12 is a diagram depicting the performance limit of the storage apparatus 102;

FIG. 13 is a diagram depicting the relation between an estimate and a measurement of the response time W;

FIG. 14 is a flowchart depicting one example of a creating process; and

FIG. 15 is a flowchart depicting one example of an evaluation support process.

### DESCRIPTION OF EMBODIMENTS

With reference to the accompanying drawings, preferred embodiments of an evaluation support program, an evaluation support method, and an evaluation support apparatus are explained.

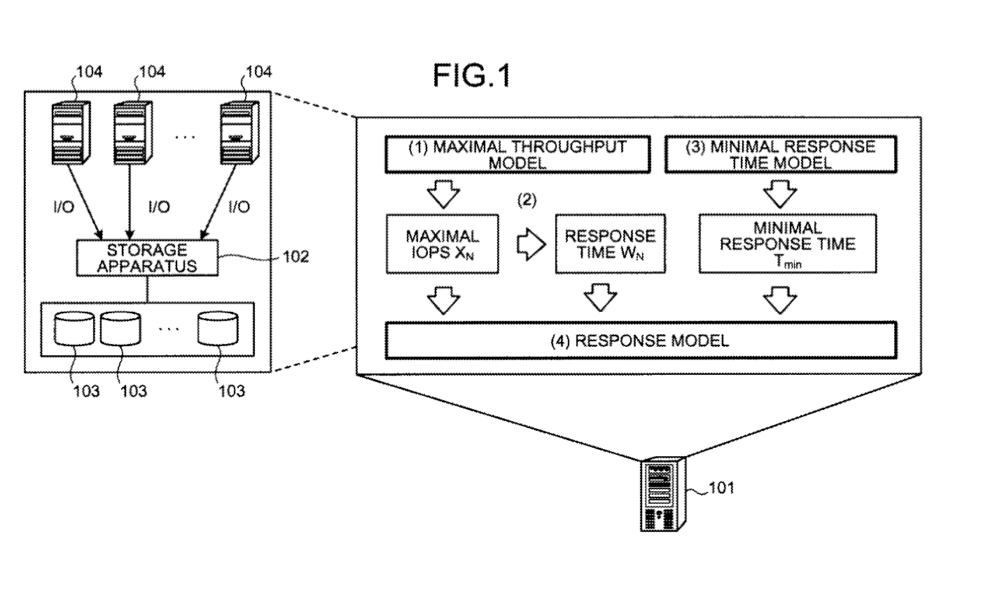

FIG. 1 is a diagram depicting one example of an evaluation support method. In FIG. 1, an evaluation support apparatus 101 is a computer that supports the evaluation of the performance of a storage apparatus 102. For example, the evaluation support apparatus 101 enables the prediction of the performance of the storage apparatus 102 with load given to the storage apparatus 102.

The storage apparatus 102 is a computer that includes one or more storage devices 103. The storage apparatus 102 receives an Input/Output (I/O) request from a client terminal 104, and gives data to and acquires data from the storage devices 103.

The storage device 103 is, for example, a hard disk, a magnetic tape, an optical disk, or a flash memory. The storage apparatus 102 is, for example, an apparatus to which the redundant arrays of independent disks (RAID) 1, 5, 6, etc. technique is applied. The RAID technique enhances fault tolerance with redundancy.

Factors for the performance of the storage apparatus 102 are, for example, Input Output Per Second (IOPS), the I/O size, and the performance of the storage devices 103. IOPS indicates the number of times an I/O request has been issued per one second. The I/O request is a write request or a read request.

The I/O size is the amount of data input to or output from the storage devices 103 in response to the I/O request. IOPS and the I/O size represent the load given to the storage apparatus 102. The performance of the storage device 103 is expressed by, for example, storage capacity of the storage devices 103, the number of storage devices 103, and a seek time.

When multiple users access the storage apparatus 102, a storage area of the storage apparatus 102 may be divided for each user or multiple users share a storage area of the storage apparatus 102. When a storage area is provided for each user, the location of the fraction of the storage area in the storage devices 103 influences the performance. However, the difference of the performance due to the physical location is less influential than the factors that determine the performance of the storage apparatus 102. Therefore, the embodiments assume that multiple users share a storage area of the storage apparatus 102.

The I/O request is classified into two types depending on whether the position pointed by the I/O request is continuous: sequential I/O and random I/O. The sequential I/O has better performance than the random I/O in many cases. However, in order to predict the performance in the worst case, here the random I/O is selected as an I/O request. The selection of the random I/O enables the effect of cache in the storage apparatus to be disregarded.

A response time for each I/O request varies depending on, for example, the I/O size of each request. Even when multiple users use the storage apparatus 102, the average performance (for a read request) of the storage apparatus 102 is acquired by averaging the load of all the users. Thus, it is assumed here that load of the storage apparatus 102 is the averaged load of all the users.

An evaluation support process conducted by the evaluation support apparatus 101 is explained.

(1) The evaluation support apparatus 101 creates a maximum throughput model that expresses the maximal performance of the storage apparatus 102 in response to a read request. The state where the storage apparatus 102 maximizes the processing of I/O requests is the one where the time interval of I/O requests issued from the client terminal 104 equals a response time for I/O requests. Here, the maximal throughput model is expressed by the maximal IOPS, the number of I/O requests that can be processed by the storage apparatus 102 per unit time.

Factors that determine the maximal performance for a read request are, for example, the I/O size of a read request, the number of storage devices 103, and a usage ratio that indicates a ratio of a storage area being used to the entire storage area of the storage apparatus 102.

Hereinafter, the average I/O size of a read request is written as I/O size r. The number of storage devices 103 is written as number R. The ratio of a storage area being used to the entire storage area of the storage apparatus 102 is written as usage ratio v. The capacity of one or more storage devices 103 is written as capacity D. A storage area being used in the storage apparatus 102 is written as capacity P.

When the RAID 5 scheme is applied to the storage apparatus 102, there are several data disks and one parity disk but number R indicates the number of data disks. Usage ratio v is expressed by v=P/DR. The unit of capacity D and capacity P is, for example, GB.

Since the maximal performance means that the time interval of I/O requests equals a response time to I/O requests, factors that determine the maximal performance for a read request are ones that determine a response time to a read request. A response time to a read request is decomposed into a seek time and a data transfer time.

The seek time is the time required to seek a location to which data is written or to which data is read from within the storage device 103. The seek time can be estimated with usage ratio v. For example, the seek time can be estimated to be (v+0.5)^{0.5}.

The data transfer time is the time consumed to finish the writing or reading of data since the location is specified. The data transfer time can be estimated with I/O size r of a read request. For example, the data transfer time can be estimated using a linear expression of I/O size r “ar+b”.

The storage 102 can process read requests in parallel when number (R) is large. For example, under the RAID 5 scheme, the storage apparatus 102 can process read request in parallel when the number of data disks is large. The larger the number (R) is, the better the performance of the storage apparatus 102 becomes.

The performance of the storage apparatus 102 varies depending on the number of users who issue I/O requests simultaneously. Here, the number of users who issue I/O requests simultaneously is called “multiplicity”. Multiplicity can be defined as how many processes for I/O requests overlap per unit time. The detailed explanation about the multiplicity will be given later with reference to FIG. 5.

Thus, the evaluation support apparatus 101 can acquire the maximal IOPS using Equation (1) below. Since the performance of the storage apparatus varies according to multiplicity, multiplicity is fixed to a given value N here. The given value N is, for example, a limit value of multiplicity (for example, N=30) that has been set to firmware of the storage apparatus 102. Hereinafter, multiplicity of N is written as “multiplicity (N)”.

X_{N} denotes the maximal IOPS under multiplicity (N). C denotes a constant unique to the storage apparatus 102 under multiplicity (N). r denotes the average I/O size of a read request. The unit of I/O size is, for example, KB. R denotes the number of storage devices 103. v denotes the usage ratio.

X_{N}=C×(1/(r+64))×R^{0.55}×(v+0.5)^{0.5} (1)

Equation (1) above is derived from the statistical analysis of results of experiments where load is given to the storage apparatus 102. Constant C can be one value when the storage devices 103 are of the same type. The types of storage devices 103 are, for example, a Solid State Drive (SSD), a Serial Attached SCSI (SAS), and a nearline-SAS (NL-SAS).

(2) The evaluation support apparatus 101 calculates a response time (W_{N}) to a read request based on multiplicity (N) and the maximal IOPS (X_{N}) of a read request. For example, the evaluation support apparatus 101 calculates W_{N} using Equation (2) below according to Little's theorem in the mathematical theory of queues. W_{N} is the average response time. The unit of W_{N} is, for example, msec. In Equation (2), constant 1000 is incorporated in order to change the unit from sec to msec.

W_{N}=N×1/X_{N}×1000 (2)

(3) The evaluation support apparatus 101 acquires the minimal response time Tₘᵢₙ for a read request. Tₘᵢₙ is a response time when IOPS is 0 (zero). Tₘᵢₙ depends on a minimal time required for the storage device 103 to respond to a read request, or the seek time or the data transfer time of the storage device 103.

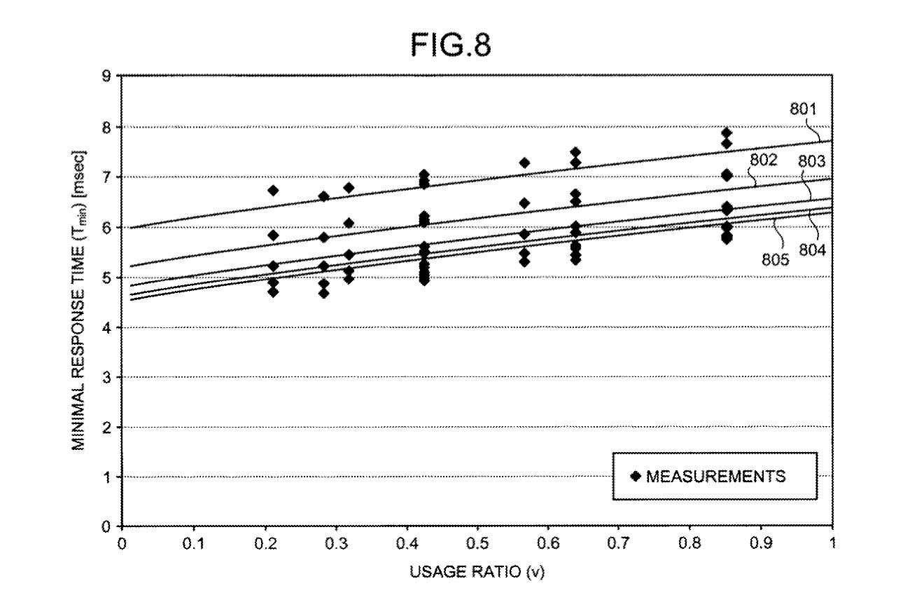

Tₘᵢₙ may be calculated by the evaluation support apparatus 101 or may be acquired from a library that stores the maximal response time and the storage apparatus 102 associated with each other. The evaluation support apparatus 101 may acquire Tₘᵢₙ from the input operation of a user. The detail of the calculation of Tₘᵢₙ will be explained later with reference to FIG. 8.

(4) The evaluation support apparatus 101 creates a response model that expresses a response time (W) for a read request based on W_{N}, X_{N}, and Tₘᵢₙ. For example, the response model is a function of IOPS (X) expressing a response time W that increase exponentially as X increases.

The evaluation support apparatus 101 creates a response model using Equation (3) below where W is the average response time for a read request. The unit of W is, for example, msec. α₁ denotes a coefficient when a read mixing ratio is 1. The read mixing ratio is a ratio of IOPS for a read request to IOPS for both read and write requests.

W=e^{α}_{₁}^{x}+Tₘᵢₙ−1 (3)

Equation (3) above is derived from the statistical analysis of results of experiments where load is given to the storage apparatus 102.

The evaluation support apparatus 101 substitutes W_{N} into W, X_{N} into X, and Tₘᵢₙ into Equation (3) and outputs α₁. The evaluation support apparatus 101 creates the response model with α₁ and Tₘᵢₙ.

As explained above, according to the evaluation support apparatus 101, a response model can be created, predicting a response time (W) that increases exponentially as IOPS (X) increases. As a result, the performance of the storage apparatus 102 with arbitrary load given can be predicted. Further, by predicting the performance of the storage apparatus 102 with arbitrary load given, the performance of the storage apparatus 102 can be guaranteed for a user.

The evaluation support apparatus 101 calculates a response time W, the average response time for a read request, by statistically analyzing a response time for a read request. As a result, load and time required for the performance prediction of the storage apparatus 102 are reduced in comparison with the performance prediction simulating the operation of firmware in the storage apparatus 102 using software.

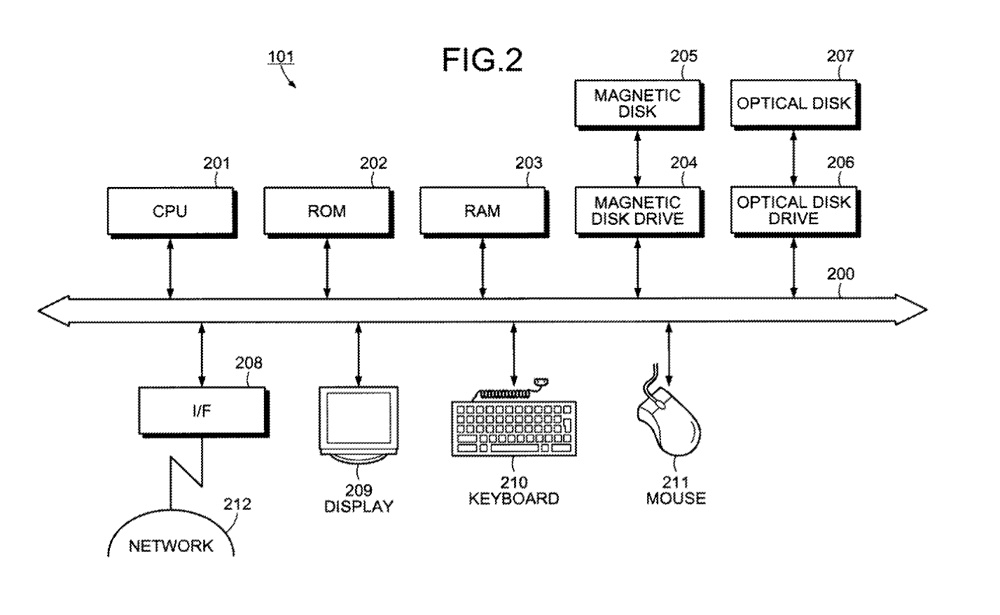

FIG. 2 is a diagram depicting a hardware configuration of the evaluation support apparatus 101. The evaluation support apparatus 101 includes a central processing unit (CPU) 201, a read-only memory (ROM) 202, a random access memory (RAM) 203, a magnetic disk drive 204, a magnetic disk 205, an optical disk drive 206, an optical disk 207, an interface (I/F) 208, a display 209, a keyboard 210, and a mouse 211, respectively connected by a bus 200.

The CPU 201 governs overall control of the evaluation support apparatus 101. The ROM 202 stores therein various programs such as a boot program. The RAM 203 is used as a work area of the CPU 201. The magnetic disk drive 204 controls the reading and writing of data with respect to the magnetic disk 205. The magnetic disk 205 stores the data written under the control of the magnetic disk drive 204.

The optical disk drive 206 controls the reading and writing of data with respect to the optical disk 207 under the control of the CPU 201. The optical disk 207 stores the data written under the control of the optical disk drive 206. A computer reads the data stored in the optical disk 207.

The I/F 208 is connected to a network 212 via a communication line or wirelessly and is connected to other devices via the network 212. The I/F 208 governs the network 212 and the internal interface, and controls the input/output of data to/from an external device. The I/F 208 may be a modem or a LAN adapter. The network 212 may be the Internet, a local area network (LAN), or a wide area network (WAN).

The display 209 displays icons, cursors, tool boxes, or various data such as texts, images, and function information. For example, a CRT, a TET liquid crystal display, a plasma display, etc., can be employed as the display 209.

The keyboard 210 includes, for example, keys for inputting letters, numerals, and various instructions and performs the input of data. Alternatively, a touch-panel-type input pad or numeric keypad, etc. may be adopted. The mouse 211 is used to move the cursor, select a region, or move and change the size of windows.

Configuration of the evaluation support apparatus 101 may omit the optical disk drive 206, the optical disk 207, and the mouse 211. The evaluation support apparatus 101 may further include a scanner or a printer.

An example of apparatus information used by the evaluation support apparatus 101 is explained. The apparatus information is information related to the storage apparatus 102. In the explanation below, it is supposed that the storage apparatus 102 includes storage devices 103 as hard disks that form RAID groups according to PRAID 5.

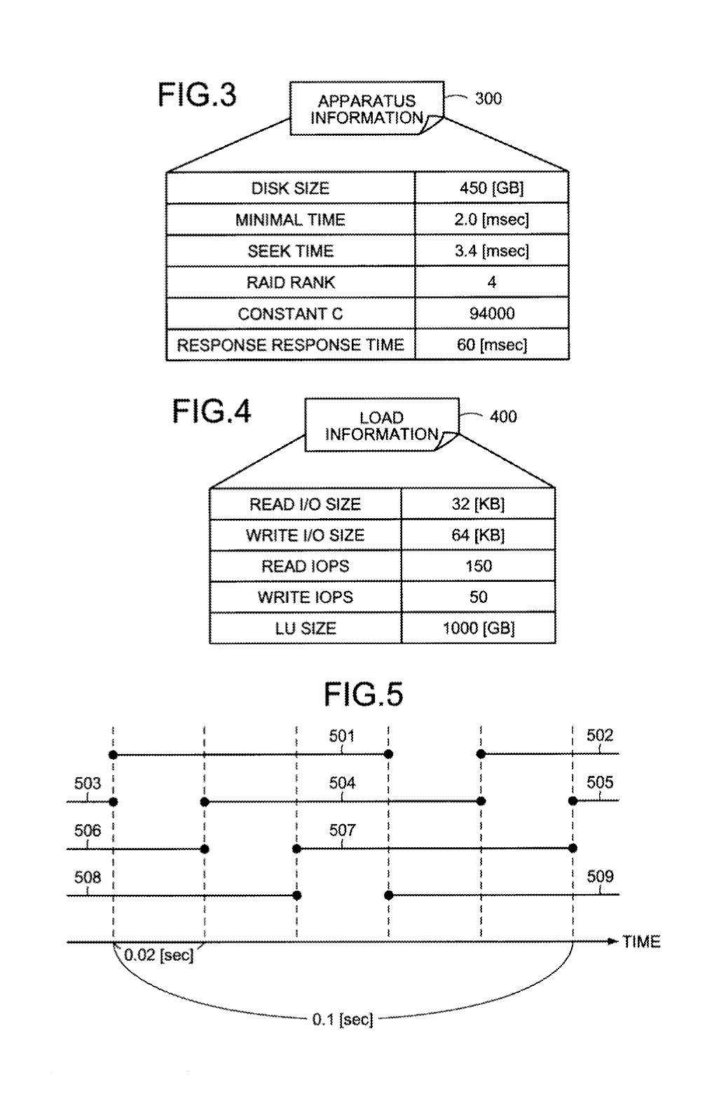

FIG. 3 is a diagram depicting an example of apparatus information. In FIG. 3, apparatus information 300 provides a response time limit, constant C, a RAID rank, a seek time, a minimal time, a disk size of the storage apparatus 102.

The disk size (hereinafter “disk size (D)”) is the capacity of a hard disk. The minimal time (hereinafter “minimal time (L)”) is the average of a minimal time required for a hard disk to respond to a read request. For example, the minimal time (L) equals the time from the receipt of an I/O request to the completion of data input/output less the seek time and the data transfer time.

The seek time (hereinafter “seek time (S)”) is the average seek time of a hard disk. The RAID rank (hereinafter “RAID rank (R)”) is the number of data disks among hard disks that include several data disks and one parity disk.

Constant C is a value that is included in Equation (1) and is unique to the storage apparatus 102. The given value N for multiplicity (N) is set 30 (N=30). The response time limit (hereinafter “response time limit (Wₘₐₓ)”) is the average response time for a read request when a write cache overflows. The write cache temporarily stores a write request. As the minimal time (L) and the seek time (S), those made public by a manufacturer of a hard disk may be used.

An example of load information used by the evaluation support apparatus 101 is explained. The load information is information that expresses load on the storage apparatus 102.

FIG. 4 is a diagram depicting an example of the load information. In FIG. 4, load information 400 provides READ I/O size, WRITE I/O size, READ IOPS, WRITE IOPS, and Logical Unit (LU) size.

The READ I/O size is the average of the amount of data that is read out when a read request is issued. In other words, the READ I/O size is the I/O size (r). The WRITE I/O size is the average of the amount of data that is written when a write request is issued. The READ IOPS is the average of the number of read requests issued in one second. In other words, the READ IOPS is the average of the number of read requested processed by the storage apparatus 102 in one second.

The WRITE IOPS is the average of the number of write requests in one second. In other words, the WRITE IOPS is the average of the number of write requests processed by the storage apparatus 102 in one second. The LU size (hereinafter “LU size (P)”) is the sum of LU sizes of all users who use the storage apparatus 102. LU is management unit for managing a storage area in the RAID groups.

Multiplicity is explained that expresses the number of users simultaneously issuing I/O requests to the storage apparatus 102.

FIG. 5 is a diagram depicting an example of multiplicity. In FIG. 5, process time periods 501-509 for processing I/O requests when the I/O requests for the storage apparatus 102 are processed in parallel. A black circle at the left end of the process time period 501 indicates the instant when an I/O request is received. A black circle at the right end of the process time period 501 indicates the instant when the I/O request is responded to.

Here, multiplicity is defined as the average of the number of overlapping process time periods per one second. In this case, multiplicity is acquired from Equation (4) below according to Little's theorem. IOPS denotes the average of the number of I/O requests issued in one second. Response time denotes the average response time to an I/O request.

Multiplicity=IOPS×Response time (4)

In FIG. 5, an I/O request occurs every 0.02 seconds. Thus, IOPS becomes 50. A response time is 0.06 [sec]. Therefore, the average of response time is 0.06 [sec]. Multiplicity is 3 (50×0.06=3).

Multiplicity expresses the degree of overlap of process time periods, namely, the length of a queue that stores I/O requests. Thus, larger multiplicity means that load of the storage apparatus 102 is accumulating. Multiplicity functions as an indicator for evaluating the performance of the storage apparatus 102.

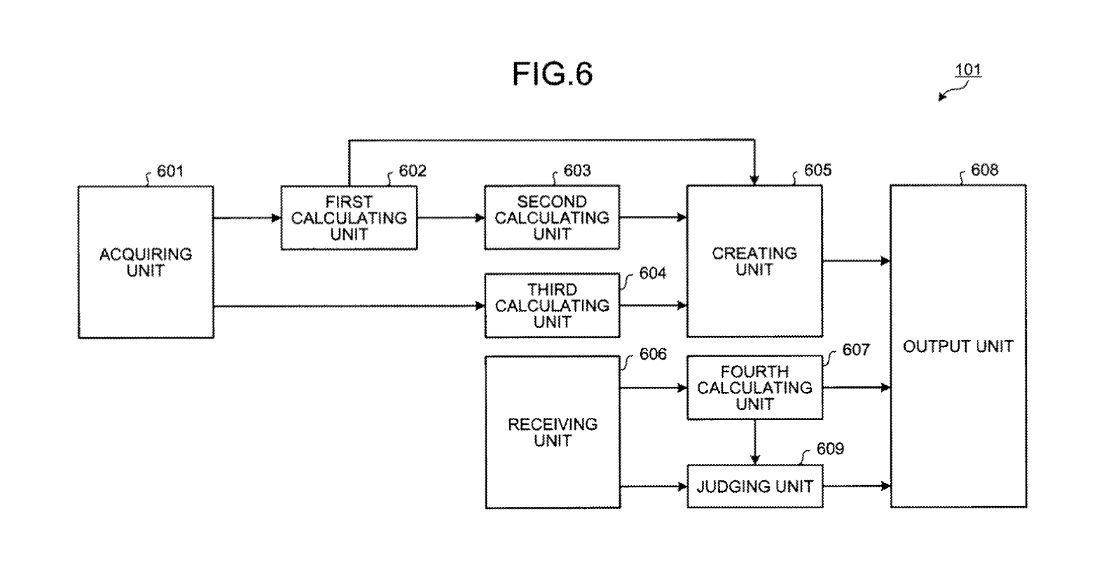

An exemplary functional configuration of the evaluation support apparatus 101 is explained. FIG. 6 is a diagram depicting a functional configuration of the evaluation support apparatus 101. In FIG. 6, the evaluation support apparatus 101 includes an acquiring unit 601, a first calculating unit 602, a second calculating unit 603, a third calculating unit 604, a creating unit 605, a receiving unit 606, a fourth calculating unit 607, an output unit 608, and a judging unit 609. The acquiring unit 601 to the judging unit 609 function as a control unit and are implemented by the I/F 208 or the CPU executing a program stored in a storage device such as the ROM 202, the RAM 203, the magnetic disk 205, and the optical disk 207. Output from each element is stored in a storage device such as the RAM 203, the magnetic disk 205, and the optical disk 207.

The acquiring unit 601 acquires apparatus information about the storage apparatus 102 that is evaluated. The apparatus information includes, for example, the response time limit (Tₘₐₓ), constant C in Equation (1), the seek time (S), the RAID rank (R), and the disk size (D) of the storage apparatus 102.

For example, the acquiring unit 601 acquires the apparatus information 300 of FIG. 3 via user operation of the keyboard 210 or the mouse 211 of FIG. 2. The acquiring unit 601 may acquire the apparatus information 300 from the storage apparatus 102 via the network 212.

The acquiring unit 601 also acquires load information about the storage apparatus 102. The load information may include the average I/O size, the average IOPS, and the LU size (P).

For example, the acquiring unit 601 acquires the load information 400 of FIG. 4 via user operation of the keyboard 210 or the mouse 211. The acquiring unit 601 may receive the load information 400 from an external computer via the network 212.

The first calculating unit 602 calculates the maximal IOPS (X_{N}) of the storage apparatus 102 under multiplicity (N). The maximal IOPS (X_{N}) is the maximum number of read requests that can be processed by the storage apparatus 102 per unit time under multiplicity (N). N of multiplicity (N) is determined beforehand by, for example, a user and received via an input operation.

For example, the first calculating unit 602 calculates the maximal IOPS (X_{N}) using Equation (1) based on the apparatus information and the load information. An example of the calculation of the maximal IOPS (X_{N}) will be explained later.

The second calculating unit 603 calculates the response time (W_{N}) based on the maximal IOPS (X_{N}). For example, the second calculating unit 603 calculates the response time (W_{N}) using Equation (2). An example of the calculation of the response time (W_{N}) will be explained later.

The third calculating unit 604 calculates the minimal response time (Tₘᵢₙ). The minimal response time (Tₘᵢₙ) is a response time when IOPS, the load of the storage apparatus 102, is 0 (zero). In other words, the minimal response time (Tₘᵢₙ) is a response time for a read request when multiplicity is 0 (zero).

For example, the third calculating unit 604 calculates the minimal response time (Tₘᵢₙ) using Equation (5) below, based on the apparatus information and the load information. Tₘᵢₙ denotes the minimal response time for a read request. L denotes the average of the minimal time required for a hard disk to respond to a read request. S denotes the average of the seek time of a hard disk. v denotes the usage ratio. r denotes the average of the I/O size.

Tₘᵢₙ=L+S×(v+0.5)^{0.5}+0.01.2r (5)

Equation (5) is derived from the statistical analysis of results of experiments where load is given to the storage apparatus 102. An example of the calculation of the minimal response time (Tₘᵢₙ) will be explained later.

The creating unit 605 creates a response model expressing a response time (W) for a read request of the storage apparatus 102, based on the response time (W_{N}) and the maximal IOPS (X_{N}). The response model is a function of IOPS (X) expressing a response time (W) that exponentially increases as the IOPS (X) increase.

For example, the creating unit 605 creates the response model using Equation (3). According to the response model, the response time (W) for a read request with the storage apparatus 102 under an arbitrary load is obtained and the performance of the storage apparatus 102 can be evaluated. An example of the response model will be explained later.

Functions of each element when the storage apparatus 102 is under an arbitrary load are explained with regard to the performance and the performance index of the storage apparatus 102. The load given to the storage apparatus 102 is, for example, IOPS. The performance of the storage apparatus 102 is, for example, a response time. The performance index of the storage apparatus 102 is, for example, multiplicity.

The receiving unit 606 receives specification of an evaluation target IOPS (hereinafter, evaluation target IOPS (X)). The evaluation target IOPS (X) indicates load given to the storage apparatus 102 and can be manipulated by a user. For example, the receiving unit 606 receives the evaluation target IOPS (X) by user input via operation of the keyboard 210 or the mouse 211.

The fourth calculating unit 607 calculates an evaluation target response time (hereinafter, evaluation target response time (W)) by substituting the evaluation target IOPS (X) into the response model.

The output unit 608 outputs the evaluation target response time (W). In this way, a user can evaluate the performance of the storage apparatus 102 for a case where the storage apparatus 102 is subject to an evaluation target IOPS (X).

The output may be displayed on the display 209, be transmitted to an external computer via the I/F 208, sent to a printer (not shown), or stored to a storage device such as the RAM 203, the magnetic disk 205, and the optical disk 207.

The fourth calculating unit 607 calculates a value of multiplicity (hereinafter, evaluation target multiplicity (N)) based on the evaluation target IOPS (X) and the evaluation target response time (W). For example, the fourth calculating unit 607 calculates the evaluation target multiplicity (N) using Equation (6) below. N denotes the evaluation target multiplicity. X denotes the evaluation target IOPS. W denotes the evaluation target response time.

N=X×W×1/1000 (6)

The judging unit 609 sets a limit value of multiplicity (hereinafter, multiplicity (Nₗᵢₘᵢₜ)) that expresses the performance limit of the storage apparatus 102. The multiplicity (Nₗᵢₘᵢₜ) is set such that the storage apparatus 102 cannot provide the required performance when multiplicity exceeds multiplicity (Nₗᵢₘᵢₜ).

As explained above, multiplicity indicates the length of a queue that stores I/O requests. When the storage apparatus 102 stores I/O requests in a queue, information concerning the I/O requests is stored in the memory of the storage apparatus 102. Thus, multiplicity (Nₗᵢₘᵢₜ) may be set based on the capacity of the memory used by the storage apparatus 102. For example, the judging unit 609 may set the multiplicity (Nₗᵢₘᵢₜ) through a user input operation via the keyboard 210 or the mouse 211.

The judging unit 609 also judges whether the evaluation target multiplicity (n) is larger than the multiplicity (Nₗᵢₘᵢₜ). The output unit 608 may output a result of the comparison. As a result, a user can judge whether the performance of the storage apparatus 102 exceeds the limit when the storage apparatus 102 is subject to the evaluation target IOPS (X), an arbitrary load.

The judging unit 609 may calculate the difference d between the evaluation target multiplicity (N) and the multiplicity (Nₗᵢₘᵢₜ) when the evaluation target multiplicity (N) is less than the multiplicity (Nₗᵢₘᵢₜ). The judging unit 609 may judge whether the difference d is less than a predetermined threshold Z.

The threshold Z is set in a manner that when the difference d becomes less than the threshold Z, it is determined that the performance of the storage apparatus 102 is coming close to the limit. The threshold Z is stored in a storage device such as the ROM 202, the RAM 203, the magnetic disk 205, and the optical disk 207.

When the difference d is less than the threshold Z, the output unit 608 may output a result of the difference d being less than the threshold Z. As a result, a user can tell that the performance of the storage apparatus 102 is coming close to the limit.

The output unit 608 may output the evaluation target multiplicity (N). As a result, a user compares the evaluation target multiplicity (N) and the multiplicity (Nₗᵢₘᵢₜ) and determines whether the performance of the storage apparatus 102 is coming close to the limit.

The output unit 608 may output the response model. As a result, a user can acquire the evaluation target response time (w) from a computer or by manual operation. The user can evaluate the performance of the storage apparatus 102 when the evaluation target IOPS (X), arbitrary load, is given to the storage apparatus 102.

In the above explanation, the judging unit 609 calculates the difference d when the evaluation target multiplicity (N) is less than the multiplicity (Nₗᵢₘᵢₜ). However, the embodiments are not limited to this example. For example, the judging unit 609 may calculate the difference d even when the evaluation target multiplicity (n) is larger than the multiplicity (Nₗᵢₘᵢₜ).

In this case, the output unit 608 may output a result of the evaluation target multiplicity (N) being larger than the multiplicity (Nₗᵢₘᵢₜ) and the difference d. As a result, a user can judge how much load should be reduced for the storage apparatus 102 not to exceed the performance limit.

In the explanation above, although the evaluation support apparatus 101 calculates the minimal response time (Tₘᵢₙ), the embodiments are not limited to this example. For example, the evaluation support apparatus 101 may acquire the minimal response time (Tₘᵢₙ) of the storage apparatus 102 from a library that stores a minimal response time and a storage apparatus associated with each other. The minimal response time stored in the library is acquired with the usage ratio v in Equation (5) fixed (for example, v=1, 0.5).

An example of the calculation of the maximal IOPS (X₃₀) under multiplicity (30) based on the apparatus information 300 in FIG. 3 and the load information in FIG. 4 is explained. Elements below are required to calculate the maximal IOPS (X₃₀).

### Constant C: C=94000

Disk size (D): 0=450 [GB]
RAID rank (R): R=4
LU size (P): 1000 [GB]
I/O size (r): 32 [KB]

The first calculating unit 602 calculates the usage ratio v using Equation (7) below. P denotes a (total) LU size, the summation of LU sizes of all users of the storage apparatus 102. D denotes a disk size that indicates the capacity of a hard disk. R denotes the RAID rank that indicates the number of data disks among hard disks.

v=P/(D×R) (7)

Here, the usage ratio v equals 0.556. The first calculating unit 602 substitutes constant C, the I/O size (r), the RAID rank (R), and the usage ratio v into Equation (1) and acquires the maximal IOPS (X₃₀). Here, the maximal IOPS (X₃₀) equals 1015.41.

The second calculating unit 603 substitutes the maximal IOPS (X₃₀) into Equation (2) and acquires the response time (W₃₀). Here, the response time (W₃₀) equals 29.545.

The relation between an estimate of the maximal IOPS (X₃₀) acquired with Equation (1) and a measurement of the maximal IOPS (X₃₀) acquired from experiments for the storage apparatus 102 is explained.

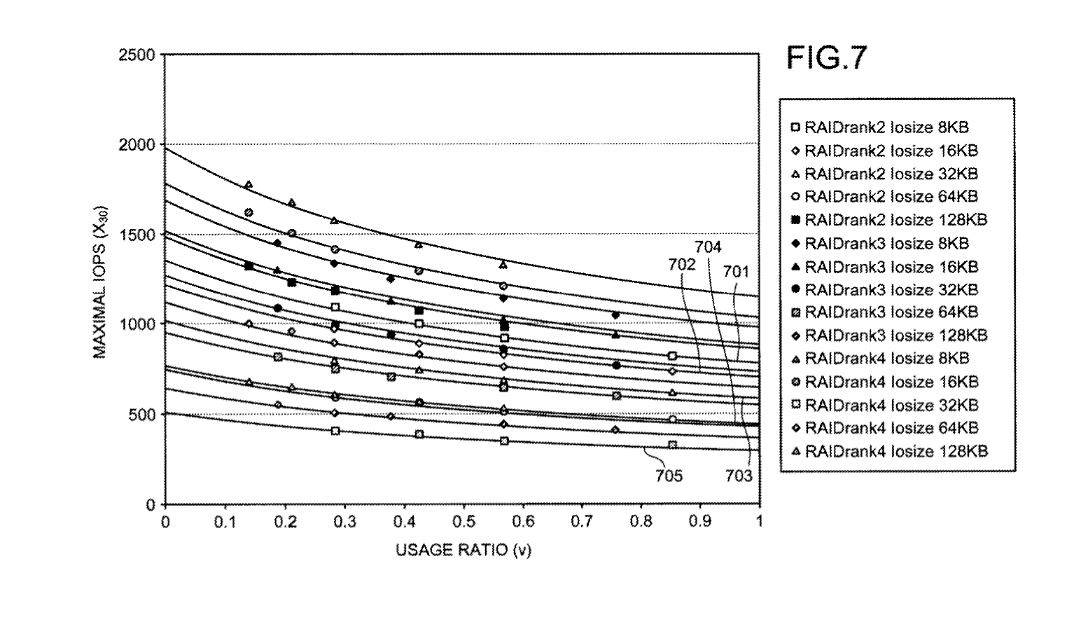

FIG. 7 is a diagram depicting the relation between an estimate and a measurement of the maximal IOPS (X₃₀). In FIG. 7, estimates obtained from Equation (1) and measurements obtained from experiments are plotted on an orthogonal coordinate system where the vertical axis is the maximal IOPS (X₃₀) and the horizontal axis is the usage ration (v). Here, parameters of the RAID rank (R) and the I/O size (r) in Equation (1) are fixed.

Curve 701 depicts the relation between the maximal IOPS (X₃₀) and the usage ratio (v) when the RAID rank (R) equals 2 and the I/O size (r) equals 8 [KB]. For the curve 701, measurements X1 to X4 of the maximal IOPS (X₃₀) are on the curve 701 and thus, there is almost no difference between the measurements and the estimates.

Curve 702 depicts the relation between the maximal IOPS (X₃₀) and the usage ration (v) when the RAID rank (R) equals 2 and the I/O size (r) equals 16 [KB]. For the curve 702, measurements X5 to X8 of the maximal IOPS (X₃₀) are on the curve 702 and thus, there is almost no difference between the measurements and the estimates.

Curve 703 depicts the relation between the maximal IOPS (X₃₀) and the usage ration (v) when the RAID rank (R) equals 2 and the I/O size (r) equals 32 [KB]. For the curve 703, measurements X9 to X12 of the maximal IOPS (X₃₀) are on the curve 703 and thus, there is almost no difference between the measurements and the estimates.

Curve 704 depicts the relation between the maximal IOPS (X₃₀) and the usage ration (v) when the RAID rank (R) equals 2 and the I/O size (r) equals 64 [KB]. For the curve 704, measurements X13 to X16 of the maximal IOPS (X₃₀) are on the curve 704 and thus, there is almost no difference between the measurements and the estimates.

Curve 705 depicts the relation between the maximal IOPS (X₃₀) and the usage ration (v) when the RAID rank (R) equals 2 and the I/O size (r) equals 128 [KB]. For the curve 705, measurements X17 to X20 of the maximal IOPS (X₃₀) are on the curve 705 and thus, there is almost no difference between the measurements and the estimates.

With reference to the apparatus information 300 in FIG. 3 and the load information in FIG. 4, an example of the calculation of the minimal response time Tₘᵢₙ of the storage apparatus 102 is explained. Elements below are required to calculate the minimal response time Tₘᵢₙ.

Minimal time L: L=2.0 [msec]
Seek time S: S=3.4 [msec]
Usage ratio v: v=0.556
I/O size r: r=32 [KB]

The third calculation unit 604 substitutes the minimal, time L, the seek time S, the usage ratio v, and the I/O size r into Equation (5) and the calculates the minimal response time Tₘᵢₙ. Here, Tₘᵢₙ=6.198.

The relation between an estimate of the minimal response time Tₘᵢₙ obtained from Equation (5) above and a measurement of the minimal response time Tₘᵢₙ obtained from experiments is explained.

FIG. 8 is a diagram depicting the relation between estimates and measurements of the minimal response time Tₘᵢₙ. In FIG. 8, curves 801 to 805 obtained from Equation (5) and measurements of the minimal response time Tₘᵢₙ (♦ in the figure) obtained from experiments are depicted on an orthogonal coordinate system where the vertical axis is the minimal response time Tₘᵢₙ and the horizontal axis is the usage ratio v.

The curve 801 depicts the relation between the minimal response time Tₘᵢₙ and the usage ratio (v) when the I/O size (r) equals 128 [KB]. The curve 802 depicts the relation between the minimal response time Tₘᵢₙ and the usage ratio (v) when the I/O size (r) equals 64 [KB]. The curve 803 depicts the relation between the minimal, response time Tₘᵢₙ and the usage ratio (v) when the I/O size (r) equals 32 [KB].

The curve 804 depicts the relation between the minimal response time Tₘᵢₙ and the usage ratio (v) when the I/O size (r) equals 16 [KB]. The curve 805 depicts the relation between the minimal response time Tₘᵢₙ and the usage ratio (v) when the I/O size (r) equals 8 [KB]. For the curves 801 to 805, the measurements of the minimal response time Tₘᵢₙ are scattered along the curves 801 to 805.

An example of a response model of the storage apparatus 102 under multiplicity (30) is explained. Elements below are required to create a response model with Equation (3) above.

The maximal IOPS X₃₀: X₃₀=1015.41
The minimal response time Tₘᵢₙ: Tₘᵢₙ=6.198
The response time W₃₀: W₃₀=29.545

The creating unit 605 substitutes W_{N} into W of Equation (3), the maximal IOPS X_{N} into X of Equation (3), and the minimal response time Tₘᵢₙ into Equation (3), and calculates coefficient α₁. Here, α₁=0.003144.

The creating unit 605 substitutes α₁ and Tₘᵢₙ into Equation (3) and creates a response model that expresses the response time W. The response model is written as Equation (8) below.

W=e^{-0.003144×}×5.198 (8)

The relation between an estimate of the response time W obtained from the response model and a measurement obtained from experiments is explained.

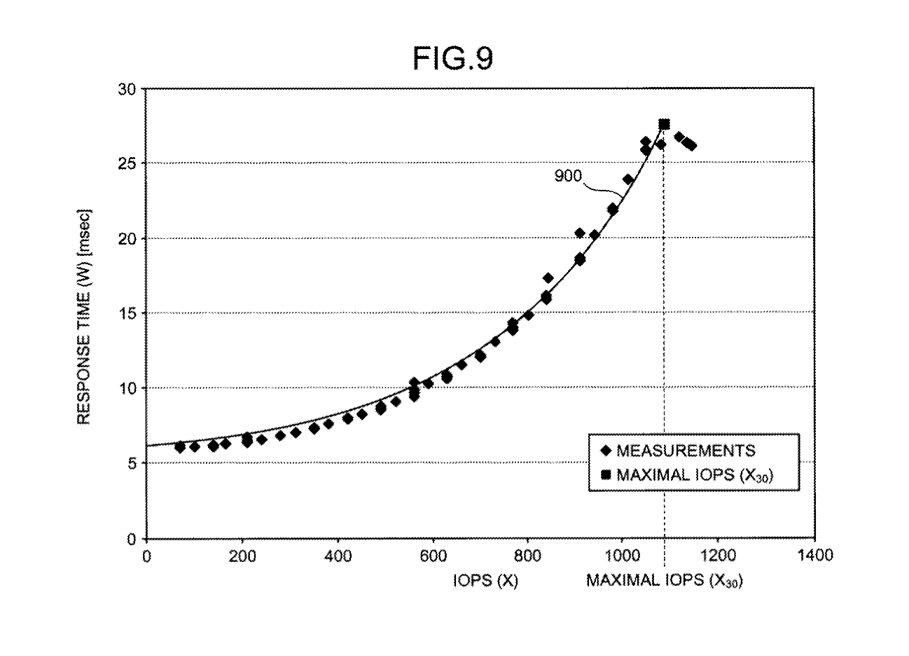

FIG. 9 is a diagram depicting the relation between estimates and measurements of the response time W. In FIG. 9, curve 900 obtained from Equation (8) and measurements of the response time W (♦ in the figure) obtained from experiments with load given to the storage apparatus 102 are depicted on the orthogonal coordinate system where the vertical axis is the response time W and the horizontal axis is IOPS (X).

For the curve 900, measurements of the response time W are on the curve 900 and thus, there is almost no difference between the measurements and the estimates. The curve 900 is the one under the conditions that the RAID rank R equals 4, the LU size P equals 1000 [GB], and the I/O size r equals 16 [KB].

In the explanation above, the performance of the storage apparatus 102 is predicted while a write request for the storage apparatus 102 is ignored. Here, the presence of a write request is considered in the prediction of the performance of the storage apparatus 102 where a write request is a negative factor for the performance.

The response time W, which exponentially increases as IOPS (X) increases, rises more sharply with read and write requests being present than with read requests alone. Due to the presence of both read and write requests, coefficient α₁ in Equation (3) becomes larger than when write requests are ignored.

The evaluation support apparatus 101 calculates the coefficient based on a read mixing ratio (c) and an I/O size ratio (t). The read mixing ratio (c) indicates a ratio of IOPS concerning a read request to IOPS concerning both read and write requests. α₁ denotes a coefficient with the read mixing ratio being equal to 1.

The read mixing ratio c (0<c≦1) is expressed by, for example, Equation (9) below. READ IOPS denotes the average of IOPS concerning a read request. WRITE IOPS is the average of IOPS concerning a write request.

c=(READ IOPS)/{(READ IOPS)+(WRITE IOPS)} (9)

The I/O size ratio (t) expresses a ratio of the I/O size of a write request (I/O size (q)) to the I/O size (r) of a read request. The I/O size (q) is the average of the amount of data written into a hard disk in response to a write request. The I/O size ratio (t) is expressed by, for example, Equation (10) below.

t=I/O size (q)/I/O size (r) (10)

For example, the creating unit 605 calculates coefficient α_{c} with Equation (11) below. α_{c} is a coefficient when the read mixing ratio is c. t denotes the I/O size ratio. α₁ is a coefficient.

$${α}_{c} = \frac{exp \{ 1.6 {t}^{0.16} ( 1 - c ) {e}^{c} \}}{{c}^{1 - c}} {α}_{1} \qquad ( 11 )$$

Equation (11) is derived from the statistical analysis of experiments where load is given to the storage apparatus 102.

With reference to the load information 400 in FIG. 4, an example of the calculation of α_{c} is explained. Elements below are required for the calculation of α_{c}.

Average of IPOS concerning read request: READ IOPS=50
Average of IOPS concerning write request: WRITE IOPS=50
Average of I/O size concerning read request: r=32 [KB]
Average of I/O size concerning write request: q=64 [KB]

### Coefficient α₁: α₁=0.003144

The creating unit 605 substitutes READ IOPS and WRITE IOPS into Equation (9) and yields the read mixing ratio c. Here, c equals 0.75. The creating unit 605 substitutes the I/O size (q) and the I/O size (r) into Equation (10) and yields the I/O size ration t. Here, t equals 2.

The creating unit 605 substitutes the read mixing ratio c, the I/O size ratio t, and coefficient α₁ into Equation (11) and yields coefficient α_{c}. Here, α_{c}=0.008702.

The creating unit 605 substitutes α_{c} and the minimal response time Tₘᵢₙ into Equation (12) below and creates a response model for read and write requests. Equation (12) is obtained from Equation (3) with α₁ replaced with α_{c}.

W=e^{α}^{_{c}}^{x}+Tₘᵢₙ−1 (12)

Here, the relation between an estimate of the response time W obtained from the read-write mixed response model and a measurement of the response time W obtained from experiments where load is given to the storage apparatus 102 is explained.

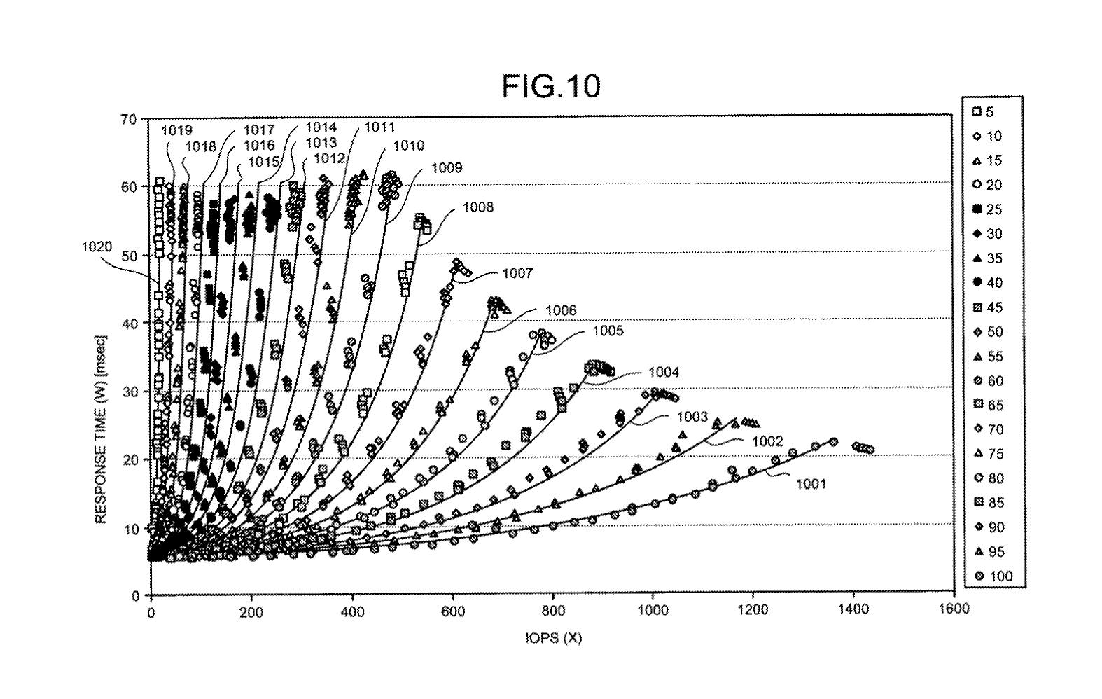

FIG. 10 is a diagram depicting the relation between estimates and measurements of the response time W. In FIG. 10, curves 1001 to 1020 obtained from Equation (12) are depicted on the orthogonal coordinate system where the vertical axis is the response time W and the horizontal axis is IOPS X. As the read mixing ratio c is reduced from 1 with the step of 0.05, curve 1001 moves toward curve 1020.

FIG. 10 also depicts measurements of the response time W obtained from the experiments where the read mixing ratio c is decreased from 1 with the step of 0.05. The read mixing ratio c is expressed in percent figures (%).

Curve 1001 is a curve obtained from Equation (12) when c=1. Curve 1002 is a curve obtained from Equation (12) when c=0.95.

For the curves 1001 to 1020, the measurements are on the curves 1001 to 1020 and thus, there is almost no difference between the estimates and the measurements. The curves 1001 to 1020 are drawn when the RAID rank R equals 4, the LU size P equals 1000 [GB], the I/O size r equals 8 [KB], and the I/O size q equals 8 [KB].

Multiplicity Nₗᵢₘᵢₜ is explained. Nₗᵢₘᵢₜ indicates the limit concerning the performance of the storage apparatus 102. First, an operation of the storage apparatus 102 upon receipt of a write request from the client terminal 104 is explained.

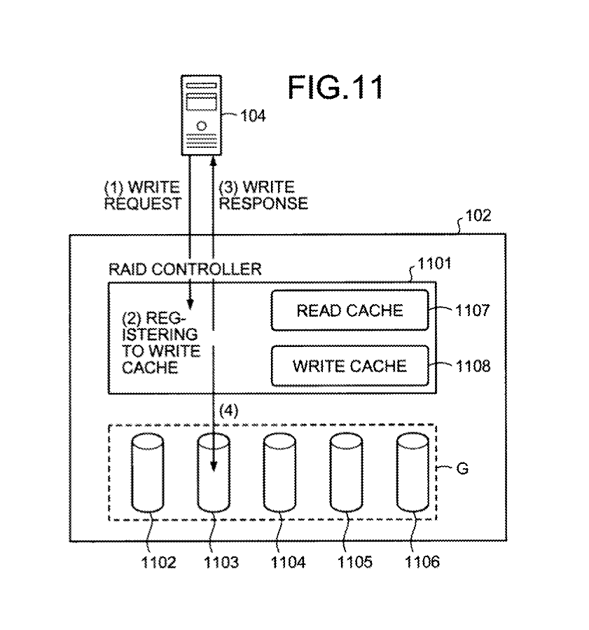

FIG. 11 is a diagram depicting an operation of the storage apparatus 102 in response to a write request. In FIG. 11, the storage apparatus 102 includes a RAID controller 1101 that controls the access to RAID group G. The PAID group G is made up of hard disks 1102 to 1106 under the RAID 5 scheme. The hard disks 1102 to 1106 correspond to the storage devices 103 possessed by the storage apparatus 102.

The RAID controller 1101 includes a read cache 1107 and a write cache 1108. The read cache 1107 is a cache that temporarily stores data read out of the RAID group G in response to a read request. The write cache 1108 is a cache that temporarily stores data subject to a process for a write request.

(1) The storage apparatus 102 receives, via the RAID controller 1101, a write request directed to the RAID group G from the client terminal 104. (2) The storage apparatus 102 writes data into the write cache 1108 via the RAID controller 1101.

(3) The storage apparatus 102 transmits to the client terminal 104 a write response via the RAID controller 1101. (4) Via the RAID controller 1101, the storage apparatus 102 reads out data from the write cache 1108 and writes the data into the RAID group G.

Thus, upon receipt of a write request, the storage apparatus 102 does not directly access the RAID group G but temporarily stores data in the write cache 1108. The storage apparatus 102 performs parity calculation for the data asynchronous with the write response for the client terminal 104. The storage apparatus 102 writes the data and the parity data into the RAID group G.

In the case of a write request, the storage apparatus 102 returns a write response when storing a write request to the write cache 1108. As a result, the response time for the write request is approximately equal to zero and does not affect multiplicity. However, there may be a case where the write cache 1108 overflows.

In this case, a write response is delayed until capacity sufficient to store incoming data in the write cache 1108 is secured. Hereinafter, a state where no further data can be written in the write cache 1108 is called write cache overflow.

When the write cache overflow occurs, the response time currently being on the order of 10 milliseconds could suddenly become on the order of seconds. Write requests occupy a queue for an I/O request.

In this case, the storage apparatus 102 cannot receive a read request because of the restriction of multiplicity. When the write cache overflows, the performance of the storage apparatus 102 for a read request reaches the limit.

An example of the performance limit of the storage apparatus 102 is explained with reference to an measurement of the response time W depicted in FIG. 10.

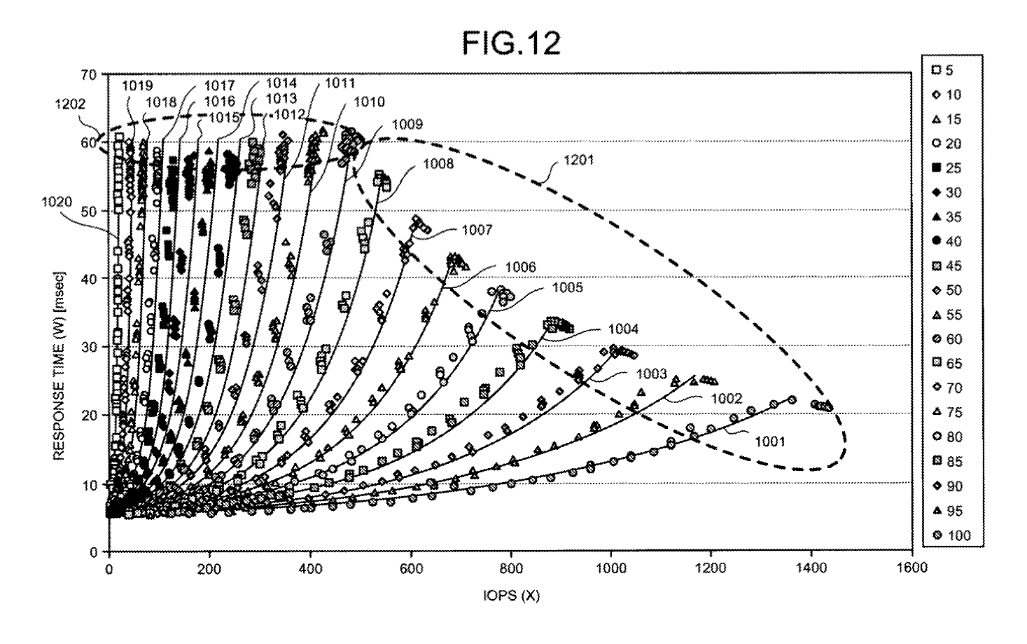

FIG. 12 is a diagram depicting the performance limit of the storage apparatus 102. In FIG. 12, a dotted closed loop 1201 expresses the performance limit of the storage apparatus 102 only due to the restriction of multiplicity with a large read mixing ratio c. A dotted closed loop 1202 expresses the performance limit of the storage apparatus 102 due to the write cache overflow.

As indicated by the dotted closed loop 1201, the performance limit due to only the restriction of multiplicity is present on an inversely proportional curve of W=(30×1000)/X. As also indicated by the dotted closed loop 1202, the performance limit due to the write cache overflow occurs when 0.05≦c≦0.6. When the performance reaches the limit due to the write cache overflow, the response time limit Wₘₐₓ for a read request is constant at approximately 60 msec.

The evaluation support apparatus 101 calculates multiplicity using Equations (4) and (12) under the condition of Wₘₐₓ being equal to 60 msec. As a result, the limit of multiplicity (hereinafter, N_{write}) can be acquired.

For example, the judging unit 609 substitutes Wₘₐₓ for W of Equation (12) and obtains Equation (13) below that expresses IOPS (X).

X=og(Wₘₐₓ−Tₘᵢₙ+1)/α_{c} (13)

The judging unit 609 substitutes Wₘₐₓ and IOPS (X) of Equation (13) into Equation (4) and yields Equation (14) that expresses multiplicity (N_{write}).

$$\begin{matrix}{N}_{write} = \frac{log ( {W}_{ma x} - {T}_{m i n} - 1 )}{{α}_{c}} \cdot \frac{{W}_{ma x}}{1000} \\ = \frac{log ( {W}_{ma x} - L - S \sqrt{v + 0.5} - 0.012 r + 1 )}{{α}_{c}} \cdot \frac{{W}_{ma x}}{1000}\end{matrix} \qquad ( 14 )$$

According to Equation (14), multiplicity N_{write} for a case where the storage apparatus 102 reaches the performance limit due to the write cache overflow can be acquired. Although the judging unit 609 has been described to acquire N_{write} from Equation (12), the judging unit may acquire N_{write} from Equation (3).

The judging unit 609 sets, using Equation (15), the lower multiplicity between N and N_{write} as multiplicity (Nₗᵢₘᵢₜ) that expresses the performance limit of the storage apparatus 102. N denotes arbitrarily given multiplicity expressing the performance limit of the storage apparatus 102.

Nₗᵢₘᵢₜ=MIN (N,N_{write}) (15)

An example of the calculation of N_{write} is explained. Elements below are required for the calculation of N_{write}. Wₘₐₓ is included in, for example, the apparatus information 300 of FIG. 3.

Response time limit Wₘₐₓ: Wₘₐₓ=60 [msec]
Minimal time L: L=2.0 [msec]
Seek time S: S=3.4 [msec]
Usage ratio v: v=0.556 [KB]
I/O size z: r=32 [KB]
Coefficient α_{c}: α_{c}=0.008702

The judging unit 609 substitutes Wₘₐₓ, L, S, v, r, and α_{c} into Equation (14) and yields N_{write}. Here, N_{write} equals 27.646.

The judging unit 609 sets N . . . , using Equation (15), where Nₗᵢₘᵢₜ=MIN(30, N_{write})=27.646, when N=30.

The judging unit 609 may calculate maximal IOPS (hereinafter, maximal IOPS (Xₗᵢₘᵢₜ)) that indicates IOPS the storage apparatus 102 can process per unit time with multiplicity being Nₗᵢₘᵢₜ. The judging unit 609 may calculate a response time (hereinafter, response time (Wₗᵢₘᵢₜ)) that is a response time of the storage apparatus 102 for a read request with multiplicity being Nₗᵢₘᵢₜ.

For example, when N_{write} is smaller than N, the judging unit 609 calculates Xₗᵢₘᵢₜ using Equation (4). In the example above, since N_{write} is smaller than N, the judging unit 609 calculates Xₗᵢₘᵢₜ by substituting Nₗᵢₘᵢₜ and Wₘₐₓ into Equation (4).

Here, Xₗᵢₘᵢₜ equals 460.1. In this case, Wₗᵢₘᵢₜ=Wₘₐₓ=60 msec.

When N_{write} is larger than N, the judging unit 609 calculates Xₗᵢₘᵢₜ with Equation (16) below. Equation (16) can be derived from Equation (4) and Equation (12).

$$\frac{{X}_{limit} ( {e}^{{α}_{c} \cdot {X}_{limit}} + {T}_{m i n} - 1 )}{1000} = 30 \qquad ( 16 )$$

Here, Xₗᵢₘᵢₜ=468.3. In this case, Wₗᵢₘᵢₜ=Wₘₐₓ=64.06 msec.

An example of the calculation of the evaluation target response time w and the evaluation target multiplicity n is explained with the load information 400 of FIG. 4. Suppose that α_{c}=0.008702 and the storage apparatus 102 is receiving the load below.

Average IOPS for read request: READ IOPS=150
Average IOPS for write request: WRITE IOPS=50
Average I/O size for read request: I/O size (r)=32 KB
Average I/O size for write request: I/O size (q)=64 KB

In this case, the fourth calculating unit 607 substitutes α_{c}, Tₘᵢₙ, and IOPS (X) into Equation (12) and yields w. Here, w=8.89 msec.

The fourth calculating unit 607 substitutes IOPS (x) and w into Equation (6) and yields n. Here, n=1.33.

Since n=1.33 when Nₗᵢₘᵢₜ=MIN(30, N_{writr})=27.646, a user judges that the storage apparatus 102 is far from the performance limit. Further, the user can tell that as load increases maintaining the I/O size r and read mixing ratio c at the current value, the storage apparatus 102 reaches the performance limit when Xₗᵢₘᵢₜ=460.1. Furthermore, the user can tell that Wₗᵢₘᵢₜ=Wₘₐₓ=60 [msec].

The relation between an estimate of W obtained from Equation (12) and a measurement of W obtained from experiments where load is given to the storage apparatus 102 is explained.

Apparatus information concerning the storage apparatus 102 is taken as the apparatus information 300 of FIG. 3. Further suppose that two LUs each being 512 GB are created from a RAID group and users A, B use the LUs with one LU given to one user.

User A subjects the LU to the load below, assuming a situation where a backup of a file is taken. User B subjects the LU to the load below, assuming a situation where images are uploaded or downloaded.

For user A:

The I/O size of a read request takes a value between 4 KB to 16 KB randomly.
The I/O size of a write request takes a value between 16 KB to 64 KB randomly.
The read mixing ratio c equals 0.75.

For user B:

The I/O size of a read request takes a value between 4 KB to 128 KB randomly.
The I/O size of a write request takes a value between 4 KB to 128 KB randomly.
The read mixing ratio c equals 0.5.

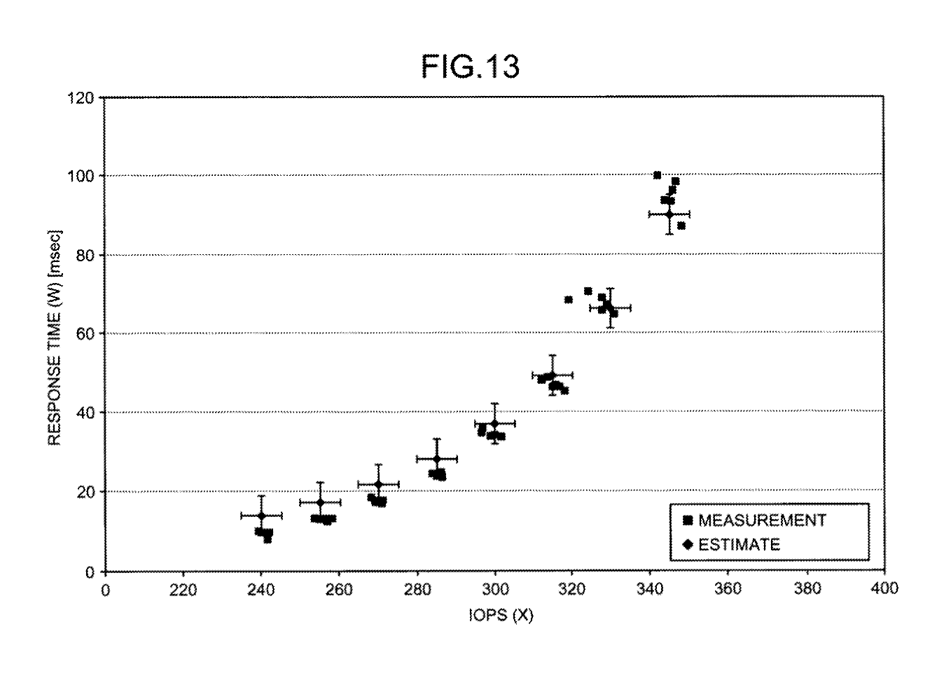

FIG. 13 is a diagram depicting the relation between estimates and measurements of the response time W. In FIG. 13, estimates (♦ in the figure) of the response time W obtained from Equation (12) and measurements (▪ in the figure) of the response time W obtained from experiments are plotted on an orthogonal coordinate system where the vertical axis is the response time W and the horizontal axis is IOPS (X).

According to FIG. 13, all measurements stay within ±5 as for IOPS and within ±5 msec as for the response time from the estimates. The differences between the estimates and the measurements are insignificant.

Various process of the evaluation support apparatus 101 are explained. A process for creating a response model for the prediction of the performance of the storage apparatus 102 is explained.

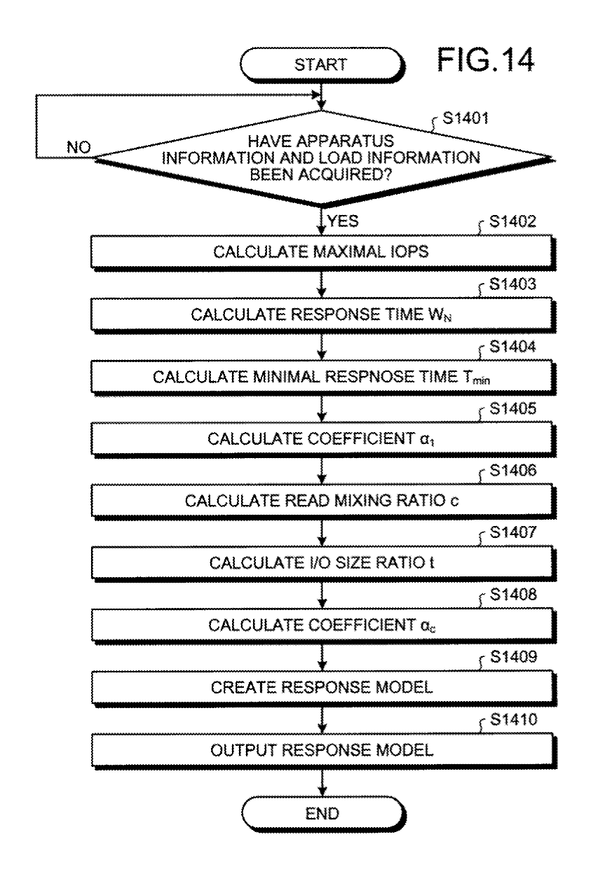

FIG. 14 is a flowchart depicting one example of the process. In FIG. 14, the evaluation support apparatus 101 determines whether apparatus information concerning the storage apparatus 102 and load information concerning the load applied to the storage apparatus 102 are acquired (step S1401).

The evaluation support apparatus 101 waits for the apparatus information and the load information to be acquired (step S1401: NO). When the evaluation support apparatus 101 acquires the apparatus information and the load information (step S1401: YES), the evaluation support apparatus calculates maximal IOPS (X_{N}) with Equation (1) based on the apparatus information and the load information (step S1402).

The evaluation support apparatus 101 calculates the response time W_{N} for a read request with Equation (2), multiplicity N, and maximal IOPS (X_{N}) (step S1403).

The evaluation support apparatus 101 calculates the minimal response time Tₘᵢₙ with Equation (5), the apparatus information, and the load information (step S1404). The evaluation support apparatus 101 substitutes the IOPS (X_{N}), the response time W_{N}, and the minimal response time Tₘᵢₙ into Equation (3) and calculates coefficient α₁ (step S1405).

The evaluation support apparatus 101 calculates the read mixing ratio c with Equation (9) and the load information (step S1406). The evaluation support apparatus 101 calculates the I/O size ratio t with Equation (10) and the load information (step S1407).

The evaluation support apparatus 101 substitutes coefficient α₁, the read mixing ratio c, and the I/O size ratio t into Equation (11) and calculates coefficient α_{c} (step S1408).

The evaluation support apparatus 101 substitutes coefficient α_{c} and the minimal response time Tₘᵢₙ into Equation (12) and creates a response model that represents the response time W for a read request (step S1409). The evaluation support apparatus 101 outputs the response model (step S1410) and the process ends.

In this way, the response time W can be estimated that exponentially increases as the IOPS (X) increases.

An evaluation support process for supporting the performance evaluation of the storage apparatus 102 is explained.

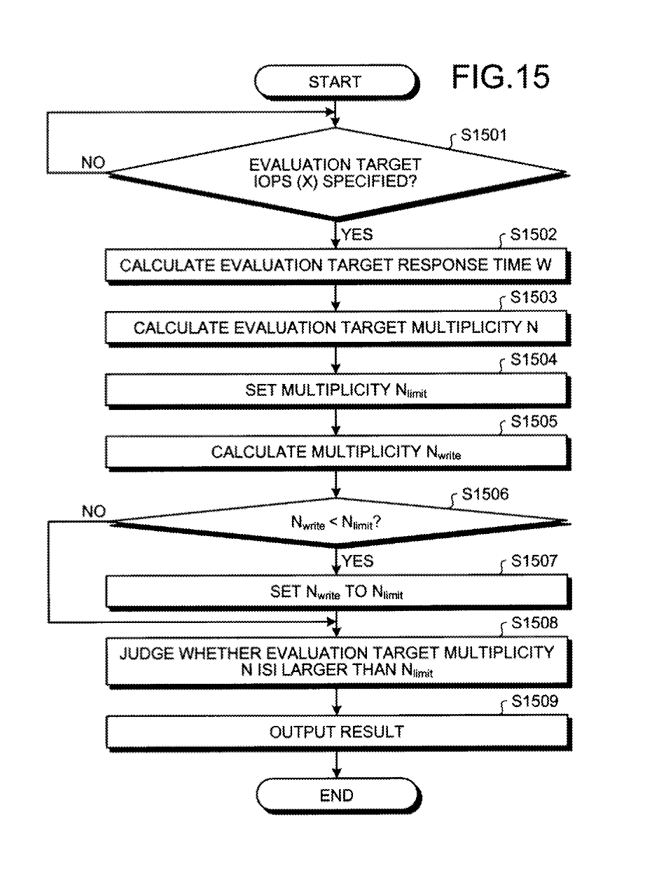

FIG. 15 is a flowchart depicting one example of the evaluation support process. In FIG. 15, the evaluation support apparatus 101 determines whether specification of an evaluation target IOPS (X) has been received (step S1501: YES).

The evaluation support apparatus 101 waits for specification of an evaluation target IOPS (X) to be received (step S1501: NO). When specification of an evaluation target IOPS (x) has been received (step S1501: YES), the evaluation support apparatus 101 substitutes the evaluation target IOPS (X) into the response model and calculates the evaluation target response time W for a read request (step S1502). The response model is created at step S1409 of FIG. 14.

The evaluation support apparatus 101 substitutes the evaluation target IOPS (X) and the evaluation target response time W into Equation (6) and calculates evaluation target multiplicity N (step S1503). The evaluation support apparatus 101 sets multiplicity Nₗᵢₘᵢₜ, which indicates the performance limit of the storage apparatus 102 (step S1504).

The evaluation support apparatus 101 substitutes the response time limit Wₘₐₓ into Equation (14) and calculates multiplicity Nₗᵢₘᵢₜ, which indicates the performance limit of the storage apparatus 102 due to the write cache overflow (step S1505). The response time limit Wₘₐₓ is, for example, included in the apparatus information acquired at step S1401 of FIG. 14.

The evaluation support apparatus 101 determines whether N_{write} is less than Nₗᵢₘᵢₜ (step S1506). If N_{write} is not less than Nₗᵢₘᵢₜ (step S1506: NO), the process goes to step S1508.

If N_{write} is less than Nₗᵢₘᵢₜ (step S1506: YES), the evaluation support apparatus 101 sets N_{write} as Nₗᵢₘᵢₜ (step S1507) and determines whether the evaluation target multiplicity n is larger than Nₗᵢₘᵢₜ (step S1508).

The evaluation support apparatus 101 outputs the result (step S1509) and the process ends. The result includes, for example, the evaluation target IOPS (x), the evaluation target response time W, the evaluation target multiplicity n, and the multiplicity Nₗᵢₘᵢₜ.

In this way, users can determines whether the performance of the storage apparatus 102 reaches the limit when the evaluation target IOPS (X), arbitrary load, is applied to the storage apparatus 102.

The result may include the maximal. IOPS Xₗᵢₘᵢₜ and the response time Wₗᵢₘᵢₜ. With these numerical information, users can specify the maximal IOPS Xₗᵢₘᵢₜ and the response time Wₗᵢₘᵢₜ when the storage apparatus 102 reaches the performance limit. The maximal IOPS Xₗᵢₘᵢₜ and the response time Wₗᵢₘᵢₜ may be calculated by the evaluation support apparatus 101 at step S1508.

As explained above, the evaluation support apparatus 101 can calculate the maximal IOPS X_{N} of the storage apparatus 102 (N=multiplicity), using Equation (1), the RAID rank R, the usage ratio v, and the I/O size r. The evaluation support apparatus 101 can calculate the response time W_{N} using Equation (2), multiplicity N, and the maximal IOPS (X_{N}). In this way, the maximal IOPS X_{N} and the response time W_{N} can be calculated.

The evaluation support apparatus 101 can calculate the minimal response time Tₘᵢₙ using Equation (5), the minimal time L, the seek time S, the usage ratio v, and the I/O size r. As a result, the minimal response time Tₘᵢₙ for a read request at IOPS X=0 can be defined.

The evaluation support apparatus 101 can create a response model that expresses the response time W for a read request, based on Equation (3), the response time W_{N}, the maximal IOPS X_{N}, and the minimal response time Tₘᵢₙ. As a result, the response time W that exponentially increases as the IOPS (X) increase can be predicted.

The evaluation support apparatus 101 can calculate coefficient α_{c} (c=mixing read ratio), using Equation (11), the read mixing ratio c, and the I/O size ratio t. The evaluation support apparatus 101 can create a response model with a read and a write request mixed with coefficient α_{c}. As a result, the write request that possesses matters such as parity calculation and the writing of parity data is considered as a factor of degrading the performance for a read request so that a response model can be created that represents the response time W for a read request in a situation where read and write requests are mixed.

The evaluation support apparatus 101 receives specification of an evaluation target IOPS (X) and substitutes the evaluation target IOPS (X) into a response model, enabling an evaluation target response time W to be calculated. As a result, the evaluation target response time W for a read request can be estimated for a case where an arbitrary load is applied to the storage apparatus 102.

The evaluation support apparatus 101 can calculate evaluation target multiplicity n using Equation (6), the evaluation target IOPS (X), and the evaluation target response time W. As a result, evaluation target multiplicity N, the performance indicator for the storage apparatus 102 under an arbitrary load, can be estimated.

The evaluation support apparatus 101 outputs a result determining whether the evaluation target multiplicity N is larger than Nₗᵢₘᵢₜ. As a result, users can see whether the storage apparatus 102 reaches the performance limit when the evaluation target IOPS (X) is given to the storage apparatus 102.

The evaluation support apparatus 101 outputs a result determining whether the difference d between the evaluation target multiplicity N and the multiplicity Nₗᵢₘᵢₜ is less than the threshold Z when the evaluation target multiplicity N is at most the multiplicity Nₗᵢₘᵢₜ. As a result, users can see that the storage apparatus 102 is coming close to the performance limit when the evaluation target IOPS (X) is applied to the storage apparatus 102.

The evaluation support apparatus 101 substitutes a response time limit Wₘₐₓ into a response model and calculates IOPS (X) for a read request when the storage apparatus 102 reaches the performance limit due to the write cache overflow. The evaluation support apparatus 101 can calculate multiplicity N_{write} using Equation (4), the IOPS (X), and the response time limit Wₘₐₓ.

The evaluation support apparatus 101 determines whether the evaluation target multiplicity N is larger than the multiplicity N_{write} when N_{write} is less than Nₗᵢₘᵢₜ and outputs a determination result. Consequently, with N_{write} being replaced with Nₗᵢₘᵢₜ, the performance of the storage apparatus 102 can be evaluated where the storage apparatus 102 reaches the performance limit due to the write cache overflow before the storage apparatus 102 reaches the performance limit due to only the multiplicity.

As set forth above, the evaluation support apparatus 101 can estimate the evaluation target multiplicity N that is an indicator for the performance of the storage apparatus 102 when arbitrary load is given to the storage apparatus 102. The evaluation support apparatus 101 compares n and Nₗᵢₘᵢₜ and determines what percentage the load applied to the storage apparatus 102 is of the maximum processing capability of the storage apparatus 102. As a result, users can judge the degree of risk and deal with the situation before the load applied to the storage apparatus 102 becomes too large for software to run.

The evaluation support method in the present embodiments can be implemented by a computer, such as a personal computer and a workstation, executing a program that is prepared in advance. The evaluation support program is recorded on a computer-readable recording medium such as a hard disk, a flexible disk, a CD-ROM, an MO, and a DVD, and is executed by being read out from the recording medium by a computer. The program can be distributed through a network such as the Internet.

According to one aspect of the embodiments, the evaluation of the performance of a storage apparatus is facilitated.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program that causes a computer to execute an evaluation support process, the evaluation support process comprising:
calculating a response time for a read request based on multiplicity and a maximal number of requests wherein the multiplicity is the number of overlaps of read or write processes for a storage apparatus per unit time, and the maximal, number of requests is the number of read requests that the storage apparatus processes per unit time; and
creating, based on the response time, the maximal number of requests, and a minimal response time for the read request, a response model that represents a response time that has the number of read requests as exponent and exponentially increases as the number of read requests increases.

2. The non-transitory computer-readable recording medium according to claim 1, the evaluation support process further comprising
calculating the maximal number of requests based on the number of storage devices in the storage apparatus, a usage ratio, an amount of data read out of the storage apparatus in response to the read request, the usage ratio representing a ratio of a currently used storage area to an entire storage area of the storage apparatus,
wherein in calculating a response time, the response time is calculated based on the multiplicity and the maximal number of requests.

3. The non-transitory computer-readable recording medium according to claim 1, the evaluation support process further comprising
calculating the minimal response time based on a minimal time required for the storage devices to respond to the read request, a seek time of the storage devices, the usage ratio, and an amount of data read out of the storage devices in response to the read request,
wherein in creating a response model, the response model is created based on the response time, the maximal number of requests, and the minimal response time.

4. The non-transitory computer-readable recording medium according to claim 1, the evaluation support process further comprising:
calculating, based on a first coefficient of the response model, a mixing ratio, and a size ratio, a second coefficient of the response model wherein the mixing ratio represents a ratio of the number of read request to the number of write and read requests per unit time, and the size ratio represents a ratio of data written into the storage devices to data read out of the storage devices; and
creating the response model by replacing the first coefficient with the second coefficient.

5. The non-transitory computer-readable recording medium according to claim 1, the evaluation support process further comprising:
receiving designation of the number of evaluation target requests;
calculating an evaluation target response time for the read request by substituting the number of evaluation target requests into the response model; and
outputting the evaluation target response time.

6. The non-transitory computer-readable recording medium according to claim 5, the evaluation support process further comprising:
calculating an evaluation target value of the multiplicity based on the number of evaluation target requests and the evaluation target response time;
determining whether the evaluation target value is larger than a limit value of the multiplicity wherein the limit value represents a performance limit of the storage apparatus; and
outputting a result.

7. The non-transitory computer-readable recording medium according to claim 6, the evaluation support process further comprising:
calculating a difference between the evaluation target value and the limit value;
determining whether the difference is less than a threshold; and
outputting a result.

8. The non-transitory computer-readable recording medium according to claim 6, the evaluation support process further comprising:
calculating the number of read requests per unit time by substituting into the response model a response time per unit time under a cache overflow; and
calculating a second limit value based on the number of read requests and the response time under the cache overflow wherein the second limit value represents a performance limit of the storage apparatus under the cache overflow,
wherein in determining, it is determined whether the evaluation target value is larger than the second limit value when the second limit value is less than the limit value.

9. An evaluation support method executed by a computer, the evaluation support method comprising:
calculating a response time for a read request based on multiplicity and a maximal number of requests wherein the multiplicity is the number of overlaps of read or write processes for a storage apparatus per unit time, and the maximal number of requests is the number of read requests that the storage apparatus processes per unit time; and
creating, based on the response time, the maximal number of requests, and a minimal response time for the read request, a response model that represents a response time that has the number of read requests as exponent and exponentially increases as the number of read requests increases.

10. An evaluation support apparatus comprising:
a calculating unit that calculates a response time for a read request based on multiplicity and a maximal number of requests wherein the multiplicity is the number of overlaps of read or write processes for a storage apparatus per unit time, and the maximal number of requests is the number of read requests that the storage apparatus processes per unit time; and
a creating unit that creates, based on the response time, the maximal number of requests, and a minimal response time for the read request, a response model that represents a response time that has the number of read requests as exponent and exponentially increases as the number of read requests increases.
